(19) United States
(12) Patent Application Publication
(10) Pub. No.: US 2026/0041944 A1
(43) Pub. Date: Feb. 12, 2026

(54) FIRE-EXTINGUISHING SHEET AND DEVICE HAVING AUTOMATIC FIRE-EXTINGUISHING FUNCTION AND INCLUDING FIRE-EXTINGUISHING SHEET

(71) Applicant: TOPPAN HOLDINGS INC., Tokyo (JP)

(72) Inventors: Yusaku HONJO, Tokyo (JP); Masato Kurokawa, Tokyo (JP); Shunta Kakegawa, Tokyo (JP); Yasuharu Shiine, Tokyo (JP); Manami Isowa, Tokyo (JP)

(73) Assignee: TOPPAN HOLDINGS INC., Tokyo (JP)

(21) Appl. No.: 19/360,906

(22) Filed: Oct. 16, 2025

Related U.S. Application Data
(63) Continuation of application No. PCT/JP2024/012451, filed on Mar. 27, 2024.

(30) Foreign Application Priority Data
Apr. 17, 2023 (JP) 2023-067116
Apr. 17, 2023 (JP) 2023-067118
Oct. 11, 2023 (JP) 2023-176188
Oct. 11, 2023 (JP) 2023-176195

(51) Int. Cl. A62C 2/06; A62C 3/16; A62D 1/00

(52) U.S. Cl. CPC A62C 2/06; A62C 3/16; A62D 1/0014

(57) ABSTRACT

A fire-extinguishing sheet according to the present disclosure has a laminate structure comprising a first fire-extinguishing agent layer and a second fire-extinguishing agent layer, wherein each of the first and second fire-extinguishing agent layers contains a fire-extinguishing agent, the fire-extinguishing agent contains at least one of a salt which is a deliquescent organic salt and a salt which is a deliquescent inorganic salt, and the second fire-extinguishing agent layer further contains an anti-deliquescence component. A device according to the present disclosure having an automatic fire-extinguishing function includes a fire-extinguishing object having a possibility of ignition, and a fire-extinguishing sheet disposed facing the fire-extinguishing object.

The present application is a Bypass Continuation of International Patent Application No. PCT/JP2024/012451, filed Mar. 27, 2024, which claims priority to and the benefit of Japanese Patent Application No. 2023-067116, filed on Apr. 17, 2023, Japanese Patent Application No. 2023-067118, filed on Apr. 17, 2023, Japanese Patent Application No. 2023-176188, filed on Oct. 11, 2023, and Japanese Patent Application No. 2023-176195, filed on Oct. 11, 2023. The contents of these applications are hereby incorporated by reference herein in their entireties.

### TECHNICAL FIELD

The present disclosure relates to a fire-extinguishing sheet and a device having an automatic fire-extinguishing function, the device including the fire-extinguishing sheet.

### BACKGROUND

In recent years, with the advancement of technology, our lives have become increasingly comfortable. On the other hand, a large amount of energy is required to create this comfort, and high safety is required in each situation such as filling and storing it at high density, transmitting it and using it. For example, in the case of automobiles, there is a risk of ignition or fire in situations such as extracting fossil fuels such as gasoline, refining fossil fuels into gasoline, and transporting fuels. Further, in the case of electronics, there is a similar risk of ignition or fire when electrical energy is transmitted through an electrical wire, when electrical energy is regulated in substations or transformers, when electrical energy is used in electrical devices in homes and factories, or when electrical energy is temporarily stored in storage batteries.

From the viewpoint of minimizing fire damage, it is desired that some kind of fire-extinguishing operation, that is, initial fire-extinguishing, be performed at the stage immediately after the fire is ignited. A possible method is to mix a fire-extinguishing agent that produces an aerosol when burned with a binder, form the mixture into a sheet-shape to produce a self-extinguishing product, and place it in the vicinity of an object having a risk of ignition in advance. The self-extinguishing product is expected to complete extinguishing the fire before humans detect the ignition from the object (see PTLs 1 and 2).
[Citation List] [Patent Literature] PTL 1: WO 2021/149766 A PTL 2: WO 2018/047762 A

### SUMMARY OF THE INVENTION

### Technical Problem

However, there is room for improvement in conventional self-extinguishing products, since the potassium salt contained as the fire-extinguishing agent is deliquescent, and depending on the storage environment, the fire-extinguishing performance may deteriorate with time. The present disclosure has been made in view of the above circumstances, and provides a fire-extinguishing sheet capable of maintaining improved fire-extinguishing performance for a long period of time, and a device having an automatic fire-extinguishing function, the device including the fire-extinguishing sheet.

### Solution to Problem

The inventors of the present invention have diligently studied and found that improved fire-extinguishing performance can be maintained for a long period of time by employing a laminate structure including at least two fire-extinguishing agent layers having different compositions, and by blending a relatively large amount of a component that suppresses deliquescence of the fire-extinguishing agent (hereinafter, referred to as an “anti-deliquescence component”) in one of the fire-extinguishing agent layers, and thus completed the invention according to the present disclosure.

An aspect of the present disclosure relates to a fire-extinguishing sheet. The fire-extinguishing sheet has a laminate structure including a first fire-extinguishing agent layer and a second fire-extinguishing agent layer, wherein each of the first and second fire-extinguishing agent layers contains a fire-extinguishing agent, the fire-extinguishing agent contains at least one of a salt which is a deliquescent organic salt and a salt which is a deliquescent inorganic salt, and the second fire-extinguishing agent layer further contains an anti-deliquescence component.

According to the above fire-extinguishing sheet, the second fire-extinguishing agent layer containing the anti-deliquescence component covers at least a part of the surface of the first fire-extinguishing agent layer, thereby reducing the contact area between the first fire-extinguishing agent layer and the air, and suppressing deliquescence of the fire-extinguishing agent contained in the first fire-extinguishing agent layer. Further, since the second fire-extinguishing agent layer itself also has fire-extinguishing performance, improved fire-extinguishing performance can be achieved compared to, for example, a case where a gas barrier film which does not have fire-extinguishing performance is laminated. The first fire-extinguishing agent layer may or may not contain an anti-deliquescence component. When the first fire-extinguishing agent layer contains an anti-deliquescence component, the content of the component in the first fire-extinguishing agent layer may be significantly smaller than that in the second fire-extinguishing agent layer.

The anti-deliquescence component may be, for example, a compound having an acid anhydride group. Specific examples of the compound include a silane coupling agent having a carboxylic acid anhydride group and an alkoxysilyl group.

From the viewpoint of achieving high stability of the properties of the fire-extinguishing sheet, the second fire-extinguishing agent layer preferably has improved hydrophobicity, and when a 2.0 μL water droplet is dropped onto the second fire-extinguishing agent layer, a contact angle 0.2 seconds after the dropping is preferably 75° or greater.

In the fire-extinguishing sheet, change in total light transmittance Δ calculated by the following formula (1) based on the result of a property stability evaluation test is preferably 50 or less.

$$Change in total light transmittance Δ = total light transmittance value after storage - initial total light transmittance value \qquad ( 1 )$$

The “property stability evaluation test” described herein means a test in which the initial total light transmittance of the fire-extinguishing sheet sealed in the barrier film is measured in accordance with the test method for the total light transmittance of transparent materials described in JIS K 7361-1:1997, and then the total light transmittance of the fire-extinguishing sheet after the fire-extinguishing sheet is stored in a constant temperature and humidity chamber at a temperature of 85° C. and a relative humidity of 85% for 168 hours is measured in the same manner as with the initial total light transmittance. The “barrier film” described herein means a film having a water vapor transmission ratio of 0.2 to 0.6 g/m²/day measured under conditions of a temperature of 40° C. and a relative humidity of 90%.

From the viewpoint of maintaining the performance of the first and second fire-extinguishing agent layers for a long period of time, the fire-extinguishing sheet is preferably contained in a packaging bag having gas barrier properties.

Another aspect of the present disclosure relates to a device having an automatic fire-extinguishing function. The device having an automatic fire-extinguishing function includes: a fire-extinguishing object having a possibility of ignition; and a fire-extinguishing sheet disposed facing the fire-extinguishing object, wherein each of first and second fire-extinguishing agent layers contains a fire-extinguishing agent configured to be ejected in response to flames, the fire-extinguishing agent contains at least one of a salt which is a deliquescent organic salt and a salt which is a deliquescent inorganic salt, and the second fire-extinguishing agent layer further contains an anti-deliquescence component. When the fire-extinguishing object is one selected from the group consisting of, for example, a switchboard, a distribution board, a control panel, a storage battery and an electrical outlet, the fire-extinguishing sheet may be installed on an inner surface of a housing that accommodates the fire-extinguishing object.

According to the study of the inventors of the present invention, as the content of the anti-deliquescence component in the fire-extinguishing agent layer increases, the responsiveness of the fire-extinguishing agent layer to flames can be reduced. On the other hand, when the content of the anti-deliquescence component in the fire-extinguishing agent layer is sufficiently small, the fire-extinguishing performance inherent to the fire-extinguishing agent is fully exhibited. Due to the second fire-extinguishing agent layer containing the anti-deliquescence component, the responsiveness of the second fire-extinguishing agent layer to flames can be reduced, and the responsiveness of the first fire-extinguishing agent layer to flames can be relatively increased. By utilizing the difference in responsiveness, it is possible to provide directionality to the fire-extinguishing agent ejected from the fire-extinguishing sheet depending on the orientation of the fire-extinguishing sheet relative to the fire-extinguishing object, or achieve fire-extinguishing at an earlier stage.

That is, when the second fire-extinguishing agent layer containing the anti-deliquescence component is disposed close to the fire-extinguishing object, it is possible to provide directionality to the fire-extinguishing agent ejected from the fire-extinguishing sheet. For example, when the fire-extinguishing sheet is disposed with the first fire-extinguishing agent layer located above and the second fire-extinguishing agent layer located below, and a bottom of the fire-extinguishing sheet is heated with a flame from below the fire-extinguishing sheet to cause the fire-extinguishing agent to react with the flame, a reaction region in the second fire-extinguishing agent layer has a smaller area than that in the first fire-extinguishing agent layer (see FIGS. 4A to 4C). Since the area of the reaction region in the second fire-extinguishing agent layer is small, an opening formed in the second fire-extinguishing agent layer by the flame and the reaction of the fire-extinguishing agent caused by the flame can function as an ejection nozzle, providing directionality to the ejected fire-extinguishing agent. By ejecting a large amount of fire-extinguishing agent toward the flame, initial fire-extinguishing can be achieved with a sufficiently high probability.

On the other hand, when the first fire-extinguishing agent layer having a high responsiveness to flames is disposed closer to the fire-extinguishing object than the second fire-extinguishing agent layer is, the fire-extinguishing agent can be ejected from the fire-extinguishing sheet at an earlier stage. For example, when the fire-extinguishing sheet is disposed on a vertically extending surface at a position horizontally separated from the fire-extinguishing object, the heat of the flame is less likely to be transmitted from the fire-extinguishing object to the fire-extinguishing sheet compared to a case where the fire-extinguishing sheet is disposed above the fire-extinguishing object. Even under such a situation, the first fire-extinguishing agent layer, which has a high responsiveness to flames, can achieve initial fire-extinguishing.

### Advantageous Effects of Invention

The present disclosure provides a fire-extinguishing sheet capable of maintaining improved fire-extinguishing performance for a long period of time, and a device having an automatic fire-extinguishing function, the device including the fire-extinguishing sheet.

### BRIEF DESCRIPTION OF THE DRAWINGS

FIG. 1 is a perspective view schematically illustrating an embodiment of a device having an automatic fire-extinguishing function according to the present disclosure.

FIG. 2 is a perspective view schematically illustrating an embodiment of a fire-extinguishing sheet according to the present disclosure.

FIG. 3 is a cross-sectional view schematically illustrating an internal structure of the fire-extinguishing sheet shown in FIG. 2.

FIG. 4A is a cross-sectional view schematically illustrating first and second fire-extinguishing agent layers after the reaction, FIG. 4B is a plan view schematically illustrating the surface of the first fire-extinguishing agent layer after the reaction, and FIG. 4C is a plan view schematically illustrating the surface of the second fire-extinguishing agent layer after the reaction.

FIG. 5 is a perspective view schematically illustrating another embodiment of a fire-extinguishing sheet according to the present disclosure.

### DETAILED DESCRIPTION

Some embodiments of the present disclosure will be described in detail below. It should be noted that the present disclosure is not limited to the following embodiments.

### <Device Having Automatic Fire-Extinguishing Function>

A device having an automatic fire-extinguishing function includes a fire-extinguishing object having a possibility of ignition, and a fire-extinguishing sheet disposed facing the fire-extinguishing object. Examples of the device having an automatic fire-extinguishing function include electrical system installations equipped with electrical wiring, cables, transformers, electric circuits, and the like. More specific examples include switchboards, distribution boards, storage batteries (for example, lithium-ion batteries) and power storage systems equipped with these. Examples of the storage batteries include mobile batteries, tool batteries and electric vehicle batteries. In addition to these examples, there are other parts where there is a risk of unintentional ignition, for example, storage battery collection boxes, trash cans, electrical outlet covers, and the like. The following description will be given of an electrical installation having an automatic fire-extinguishing function as an example.

An electrical installation includes electrical devices and a housing that accommodates the electrical devices. Examples of the electrical installation include power receiving and transforming equipment such as switchboards and distribution boards, and equipment such as operation panels and control panels for production equipment. Examples of the electrical devices include terminal blocks, transformers, breakers, capacitors, earth leakage circuit breakers, electrical wiring, storage batteries, electrical outlets, and the like provided on these panels. These electrical devices can be regarded as parts of the electrical installation where there is a risk of ignition. An electrical installation usually includes a plurality of electrical devices, and a fire-extinguishing sheet may be provided for at least one of the electrical devices, or may be provided for each of all the electrical devices. A single fire-extinguishing sheet may be provided facing a plurality of electrical devices. The above-mentioned fire-extinguishing sheets, which are improved in initial fire-extinguishing capability, can be provided in advance in these electrical installations to prevent outbreak and spread of fire.

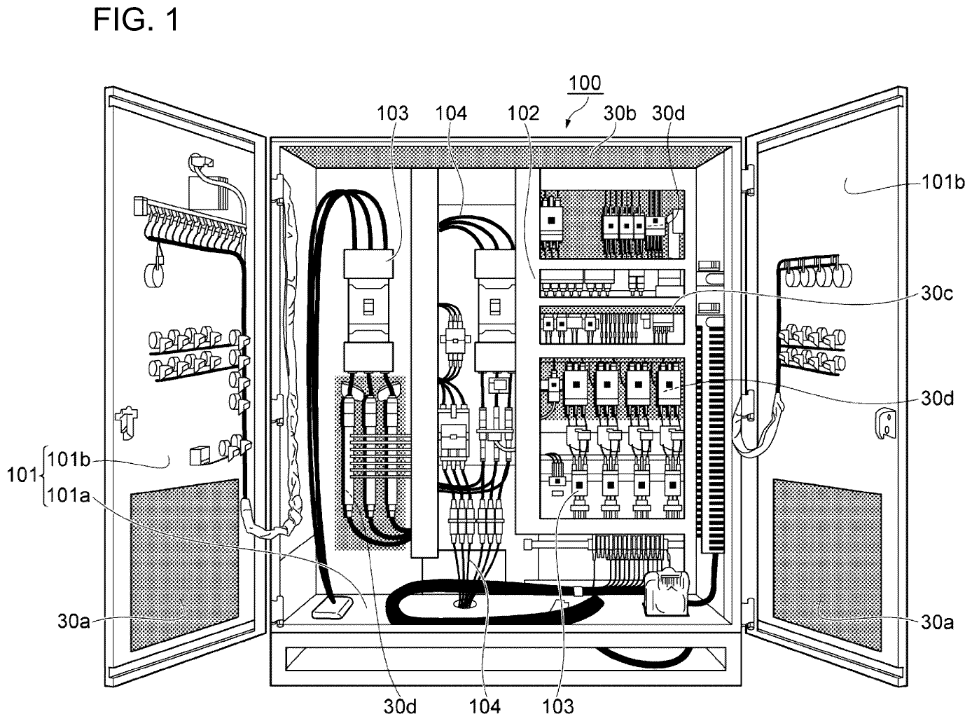

FIG. 1 is a perspective view schematically illustrating an electrical installation according to the present embodiment. FIG. 1 shows a switchboard as an example the electrical installation. An electrical installation 100 mainly includes a housing 101 having a housing section 101a that houses electrical devices and an openable door 101b, and a breaker 103 and wiring 104 as the electrical devices. Part of the wiring 104 is collectively accommodated in a wiring cover 102. The electrical installation 100 may include, for example, a fire-extinguishing sheet 30a on the side of the openable door 101b facing the electrical devices, a fire-extinguishing sheet 30b on the top surface of the housing section 101a facing the electrical devices, a fire-extinguishing sheet 30c on the underside of the wiring cover 102 facing the electrical devices (in the figure, the appropriate installation position is shown for simplicity), and a fire-extinguishing sheet 30d on the rear side of the housing section 101a facing the electrical devices, that is, on the back side of the electrical devices.

The positions of the fire-extinguishing sheets are not limited to the embodiment shown in FIG. 1, and can be appropriately adjusted according to the arrangement of the electrical devices, which are positions where there is a risk of ignition. In addition, when the distance between the fire-extinguishing sheet and the electrical devices is large, a member for adjusting the distance may be provided and the fire-extinguishing sheet may be provided on the member.

The distance between the electrical devices and the fire-extinguishing sheet can be appropriately adjusted. The distance is preferably 200 mm or less, more preferably 150 mm or less, even more preferably 120 mm or less, and still even more preferably 100 mm or less. This allows for more appropriate initial fire-extinguishing. The distance between the electrical devices and the fire-extinguishing sheet refers to the shortest distance between the electrical devices and the fire-extinguishing sheet facing the electrical devices. For example, for electrical devices disposed directly below the top surface of the housing section 101a at a distance of 200 mm or less from the top surface, a fire-extinguishing sheet can be provided on the top surface. Further, for example, for electrical devices disposed facing the openable door 101b at a distance of 200 mm or less from the openable door 101b, a fire-extinguishing sheet can be provided on the openable door 101b. It is desired to provide the fire-extinguishing sheet close to the electrical devices, but the distance between them is preferably at least 1 mm since there is a risk of contact if they are too close.

### <Fire-Extinguishing Sheet>

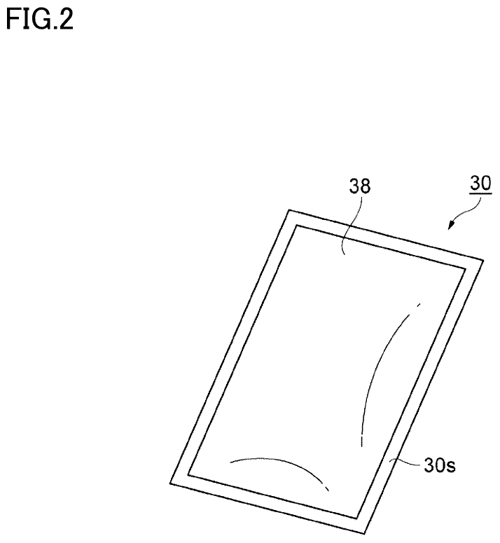

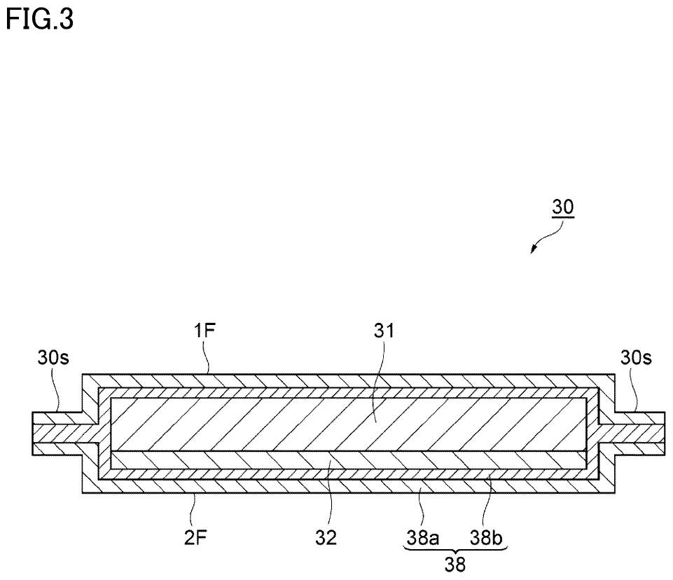

Next, the fire-extinguishing sheet will be specifically described. At least one of the fire-extinguishing sheets 30a, 30b, 30c and 30d shown in FIG. 1 has a laminate structure including a first fire-extinguishing agent layer and a second fire-extinguishing agent layer. With reference to FIGS. 2 and 3, a fire-extinguishing sheet having a laminate structure will be described. A fire-extinguishing sheet 30 shown in these figures includes a laminate composed of a first fire-extinguishing agent layer 31 and a second fire-extinguishing agent layer 32, and a packaging bag 38 containing the laminate. The packaging bag 38 includes a substrate layer 38a and a heat seal layer 38b. The fire-extinguishing sheet 30 has a seal portion 30s formed on the periphery. The fire-extinguishing sheet 30 has a surface 1F on the first fire-extinguishing agent layer 31 side and a surface 2F on the second fire-extinguishing agent layer 32 side.

In the present embodiment, each of the first and second fire-extinguishing agent layers 31 and 32 contains a fire-extinguishing agent that is ejected in response to flames. The second fire-extinguishing agent layer 32 has a lower responsiveness to flames than the first fire-extinguishing agent layer 31 does. The term “low responsiveness to flames” as used herein means that the fire-extinguishing agent is not easily ejected when heated by flames. In other words, the first fire-extinguishing agent layer 31 has a higher responsiveness to flames than the second fire-extinguishing agent layer 32. The term “high responsiveness to flames” means that the fire-extinguishing agent is easily ejected when heated by flames.

The second fire-extinguishing agent layer 32 having a relatively lower responsiveness to flames may be disposed closer to the fire-extinguishing object than the first fire-extinguishing agent layer 31 is. That is, the fire-extinguishing sheet 30 may be installed with the surface 2F of the fire-extinguishing sheet 30 facing the fire-extinguishing object. By installing the fire-extinguishing sheet 30 in this orientation, an opening formed in the second fire-extinguishing agent layer by the flame can function as an ejection nozzle as described above, providing directionality to the ejected fire-extinguishing agent. Referring now to FIG. 1, the fire-extinguishing sheets 30b and 30c are disposed above the fire-extinguishing object. It is preferred to install the fire-extinguishing sheets 30b and 30c in this orientation.

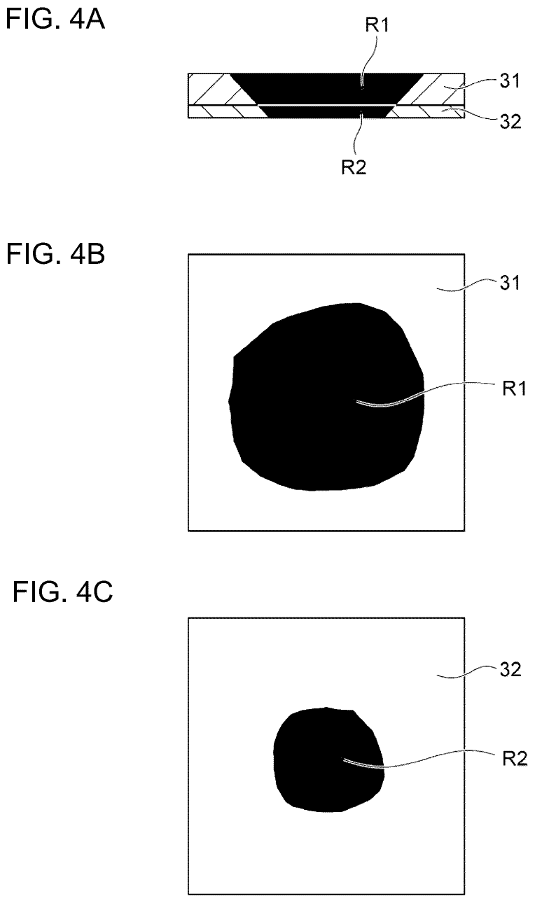

FIG. 4A is a cross-sectional view schematically illustrating the first and second fire-extinguishing agent layers 31 and 32 after the reaction. FIG. 4B is a plan view schematically illustrating the surface of the first fire-extinguishing agent layer 31 after the reaction. FIG. 4C is a plan view schematically illustrating the surface of the second fire-extinguishing agent layer 32 after the reaction. The black region in these figures represents the reaction region in the first and second fire-extinguishing agent layers 31 and 32, and indicates that the area of a reaction region R2 in the second fire-extinguishing agent layer 32 is smaller than the area of a reaction region R1 in the first fire-extinguishing agent layer 31. Typically, the reaction region in the actual fire-extinguishing sheet is composed of a center portion where a cavity is formed by ejection of the fire-extinguishing material, and a peripheral portion where the fire-extinguishing material is discolored to black due to soot. As a result of examining the appearance of the fire-extinguishing sheet after the reaction in Examples 1 and 3, which will be described later, it was found to be similar to that shown in FIGS. 4B and 4C.

The first fire-extinguishing agent layer 31 having a relatively higher responsiveness to flames may be disposed closer to the fire-extinguishing object than the second fire-extinguishing agent layer 32 is. That is, the fire-extinguishing sheet 30 may be installed with the surface 1F of the fire-extinguishing sheet 30 facing the fire-extinguishing object. By installing the fire-extinguishing sheet 30 in this orientation, the fire-extinguishing agent can be ejected from the fire-extinguishing sheet 30 at an earlier stage, as described above. Referring now to FIG. 1, the fire-extinguishing sheets 30a and 30d are disposed above the fire-extinguishing object. It is preferred to install the fire-extinguishing sheets 30a and 30d in this orientation.

The average thickness of the first and second fire-extinguishing agent layers 31 and 32 may be, for example, 30 μm to 600 μm, preferably 40 μm or greater, more preferably 100 μm or greater, and even more preferably 150 μm or greater, and 300 μm or less. The average thickness of greater than or equal to the lower limit facilitates fire-extinguishing performance, and the average thickness of less than or equal to the upper limit facilitates formation of a coating film and provides high bending resistance. The average thickness of the first fire-extinguishing agent layer 31 may be 100 μm or greater, and preferably 150 μm or greater from the viewpoint of the fire-extinguishing performance. The average thickness of the second fire-extinguishing agent layer 32 may be 30 μm or greater, preferably 40 μm or greater, more preferably 70 μm or greater, and even more preferably 100 μm or greater from the viewpoint of achieving improved fire-extinguishing performance and improved property stability, and may be 150 μm or less, preferably 130 μm or less, and more preferably 120 μm or less from the viewpoint of achieving improved handleability. From the above viewpoints, the average thickness of the second fire-extinguishing agent layer may be 100 μm or greater and 120 μm or less.

From the viewpoint of achieving improved fire-extinguishing performance, a ratio of an average thickness T1 of the first fire-extinguishing agent layer 31 to an average thickness T2 of the second fire-extinguishing agent layer 32, T1/T2, is preferably 0.8 or greater, more preferably 1.1 or greater, even more preferably 1.5 or greater, and particularly preferably 1.8 or greater. The upper limit of the ratio T1/T2 may be, for example, 5.0. The average thickness of the fire-extinguishing agent layers 31 and 32 means the average of the thicknesses at any five points in the enlarged image of the cross-section of the fire-extinguishing sheet. The area of the major surface of the fire-extinguishing agent layer may be appropriately set according to the application and installation position of the fire-extinguishing sheet.

The first and second fire-extinguishing agent layers 31 and 32 are composed of fire-extinguishing materials having different compositions. The fire-extinguishing material is prepared by forming a composition (fire-extinguishing material forming composition) containing a fire-extinguishing agent, a binder resin and an anti-deliquescence component which is blended as necessary. Forming a fire-extinguishing material using a binder resin makes it easier to maintain the properties of the fire-extinguishing agent, and reduces the frequency of replacing the fire-extinguishing sheet. The fire-extinguishing material may further contain a liquid medium. The components contained in the fire-extinguishing agent layers 31 and 32 will be described.

### (Anti-Deliquescence Component)

The anti-deliquescence component is a component blended in the second fire-extinguishing agent layer 32 in order to improve the resistance to deliquescence. The first fire-extinguishing agent layer 31 in the present embodiment does not contain an anti-deliquescence component. The contact angle formed when water droplet is dropped on the fire-extinguishing agent layer varies depending on the deliquescence resistance of the fire-extinguishing agent in the fire-extinguishing agent layer onto which the water droplet is dropped, and the higher the deliquescence resistance, the greater the contact angle. The contact angle may be measured, for example, using a portable contact angle meter PCA-1 (manufactured by Kyowa Interface Science Co., Ltd.). When a 2.0 μL water droplet is dropped onto the second fire-extinguishing agent layer 32 of the fire-extinguishing sheet, the contact angle θ.2 seconds after the dropping may be 75° or greater, preferably 85° or greater, and more preferably 90° or greater from the viewpoint of obtaining a fire-extinguishing sheet with improved property stability.

Since the anti-deliquescence component does not particularly contribute to the fire-extinguishing properties, it also serves to reduce the responsiveness of the fire-extinguishing agent layer to flames. Examples of the anti-deliquescence component include compounds having acid anhydride groups. The reason why compounds having acid anhydride groups exhibit an anti-deliquescence effect is not clear, but it is presumed that the acid anhydride groups can react with water, trapping water which has entered the fire-extinguishing agent layer and preventing deliquescence of the salt contained in the fire-extinguishing agent layer. Further, it is presumed that compounds having acid anhydride groups modify the surface of the salt, thereby improving the hydrophobicity and inhibiting contact with water.

Compounds having acid anhydride groups are not particularly limited as long as they have one or more acid anhydride groups in the molecule, which are formed by dehydration condensation of two molecules of oxoacid. Examples of the oxoacid constituting the acid anhydride group include carboxylic acids, sulfuric acid, nitric acid and phosphoric acid. Among these, a carboxylic acid is preferred as the oxoacid constituting the acid anhydride group. Examples of compounds having carboxylic acid anhydride groups include carboxylic acid anhydrides alone, such as phthalic anhydride, succinic anhydride and maleic anhydride, or copolymers containing a carboxylic acid anhydride having an unsaturated bond such as maleic anhydride as a monomer.

Compounds having acid anhydride groups may further contain alkoxysilyl groups in the molecule. When compounds having acid anhydride groups contained in the fire-extinguishing agent layer further contain alkoxysilyl groups in the molecule, the properties of the product can be maintained more stably over a long period of time. The reason for this is not clear, but it is presumed that, after the alkoxysilane is hydrolyzed, self-reaction occurs to form siloxane, which improves water resistance and film density, thereby inhibiting contact between deliquescent salt and water. The compound having an acid anhydride group and an alkoxysilyl group in the molecule may be, for example, a silane coupling agent. The silane coupling agent used as the compound having an acid anhydride group may have the same function as the binder resin in the fire-extinguishing agent layer.

The content of the compound having an acid anhydride group in the second fire-extinguishing agent layer 32 may be 10 parts by mass to 250 parts by mass, and preferably 50 parts by mass to 200 parts by mass when the mass of the binder resin contained in the second fire-extinguishing agent layer 32 is 100 parts by mass. The content of the compound having an acid anhydride group of less than or equal to the upper limit improves the coating suitability of the second fire-extinguishing agent layer 32, facilitating film formation and preventing cracking in the film, and the content of the compound having an acid anhydride group of greater than or equal to the lower limit facilitates suppression of salt deliquescence and provides sufficient fire-extinguishing performance.

In the example described above, the second fire-extinguishing agent layer 32 contains an anti-deliquescence component while the first fire-extinguishing agent layer 31 does not contain an anti-deliquescence component, but the first fire-extinguishing agent layer 31 may also contain an anti-deliquescence component. In this case, the content of the compound having an acid anhydride group in the first fire-extinguishing agent layer 31 may be significantly smaller than that in the second fire-extinguishing agent layer 32. The content of the compound having an acid anhydride group in the first fire-extinguishing agent layer 31 may be, for example, 35 parts by mass or less, and preferably 10 parts by mass or less when the mass of the binder resin contained in the first fire-extinguishing agent layer 31 is 100 parts by mass.

### (Fire-Extinguishing Agent)

The fire-extinguishing agent has properties of being ejected in response to flames. As the fire-extinguishing agent, components having any of the four elements of fire-extinguishing (starving effect, cooling effect, smothering effect, negative catalytic effect) can be used appropriately depending on the fire-extinguishing object. The fire-extinguishing agent may contain at least one of deliquescent organic salts and deliquescent inorganic salts, which generally have fire-extinguishing properties. The organic salts and inorganic salts may be used singly or in combination of two or more. The first fire-extinguishing agent layer 31 contains a first fire-extinguishing agent, and the second fire-extinguishing agent layer 32 contains a second fire-extinguishing agent.

The salt contained in the first fire-extinguishing agent may be the same compound as the salt contained in the second fire-extinguishing agent, or may be a different compound. When the salt contained in the first fire-extinguishing agent is the same compound as the salt contained in the second fire-extinguishing agent, the production efficiency of the fire-extinguishing sheet can be improved. When the salt contained in the first fire-extinguishing agent is a compound different from the salt contained in the second fire-extinguishing agent, the responsiveness to flames can be different between the first and second fire-extinguishing agent layers.

Examples of the organic salts that function as the fire-extinguishing agent include potassium salts, sodium salts and ammonium salts. From the viewpoint of usefulness for negative catalytic effect, potassium salts can be preferably used as the organic salts. Examples of the organic potassium salts include potassium carboxylates such as potassium acetate, potassium citrate (monopotassium citrate, dipotassium citrate, tripotassium citrate), potassium tartrate, potassium lactate, potassium oxalate and potassium maleate. Among these, examples of deliquescent organic potassium salts include potassium acetate, potassium citrate, potassium tartrate and potassium lactate. In particular, from the viewpoint of reaction efficiency of the negative catalytic effect of combustion, potassium citrate can be used.

Examples of the inorganic salts that function as the fire-extinguishing agent include potassium salts and sodium salts. From the viewpoint of usefulness for the negative catalytic effect, potassium salts can be preferably used as the inorganic salts. Examples of the inorganic potassium salts include potassium tetraborate, potassium carbonate, potassium hydrogen carbonate, potassium dihydrogen phosphate and dipotassium hydrogen phosphate. Among these, examples of deliquescent inorganic potassium salts include potassium carbonate, potassium dihydrogen phosphate and dipotassium hydrogen phosphate. In particular, from the viewpoint of reaction efficiency of the negative catalytic effect of combustion, potassium carbonate can be used.

The salt may be granular. The average particle size D50 of the salt may be 1 μm to 100 μm, and preferably 3 μm to 40 μm. The average particle size D50 of greater than or equal to the lower limit facilitates dispersion of the salt in the coating liquid. The average particle size D50 of less than or equal to the upper limit tends to improve the stability in the coating liquid and the smoothness of the coating film, and makes it easy to achieve a desired gloss on the surface of the fire-extinguishing agent layer. The average particle size D50 can be calculated by wet measurement using a laser diffraction type particle size distribution measurement device.

The amount of the fire-extinguishing agent may be 70 mass % to 97 mass %, and preferably 85 mass % to 92 mass % relative to the total amount of the fire-extinguishing agent and the binder resin (which may be the total amount of the fire-extinguishing agent layer). The amount of the fire-extinguishing agent of less than or equal to the upper limit facilitates suppression of salt deliquescence when the salt is deliquescent, and facilitates formation of uniform fire-extinguishing sheet, and the amount of the fire-extinguishing agent of greater than or equal to the lower limit makes it easy to maintain sufficient fire-extinguishing properties.

The fire-extinguishing agent may contain other components in addition to the above-mentioned salts. Examples of other components include an oxidizing agent for improving the reactivity of the salt, and specific examples include potassium chlorate, sodium chlorate, strontium chlorate, ammonium chlorate, magnesium chlorate, potassium nitrate, sodium nitrate, strontium nitrate, ammonium perchlorate, potassium perchlorate, basic copper nitrate, copper (I) oxide, copper (II) oxide, iron (II) oxide, iron (III) oxide and molybdenum trioxide. Among these, potassium chlorate is preferably used. From the viewpoint of further improving the fire-extinguishing performance of the fire-extinguishing sheet, at least one of the first and second fire-extinguishing agents may contain an oxidizing agent, or both the first and second fire-extinguishing agents may contain an oxidizing agent.

### (Binder Resin)

The binder resin contains at least one of a thermoplastic resin and a thermosetting resin as the resin.

Examples of the thermoplastic resin include polyolefin resins such as polypropylene resins, polyethylene resins, poly(1-)butene resins and polypentene resins, polystyrene resins, acrylonitrile-butadiene-styrene resins, methyl methacrylate-butadiene-styrene resins, ethylene-vinyl acetate resins, ethylene-propylene resins, polycarbonate resins, polyphenylene ether resins, acrylic resins, polyamide resins, polyvinyl chloride resins, polyvinyl alcohol (PVA), polyvinyl acetal resins and polyurethane resins. Among these resins, polyvinyl acetal resins and polyurethane resins can be preferably used from the viewpoint of coating film formability. Examples of the polyvinyl acetal resins include polyvinyl butyral (PVB). Among the above thermoplastic resins, polyurethane resins can be preferably used from the viewpoint of improving both coating film formability and reactivity. In addition to the above compatibility, from the viewpoint of imparting flexibility to the coating film and water resistance to the fire-extinguishing material, ether-based polyurethane resins can be preferably used.

Examples of the thermosetting resin include rubbers such as natural rubber (NR), isoprene rubber (IR), butadiene rubber (BR), 1,2-polybutadiene rubber (1,2-BR), styrene-butadiene rubber (SBR), chloroprene rubber (CR), nitrile rubber (NBR), butyl rubber (IIR), ethylene-propylene rubber (EPR, EPDM), chlorosulfonated polyethylene (CSM), acrylic rubber (ACM, ANM), epichlorohydrin rubber (CO, ECO), polyvulcanized rubber (T), silicone rubber (Q), fluororubber (FKM, FZ) and urethane rubber (U), polyurethane resins, polyisocyanate resins, polyisocyanurate resins, phenol resins, epoxy resins and polymethyl vinyl ether (PMVE)-maleic anhydride resins.

The binder resin may contain components other than the above-mentioned resins (thermoplastic and thermosetting resins). Examples of other components include curing agents, and from the viewpoint of property stability, surfactants, silane coupling agents, anti-blocking agents, adhesion-imparting agents, and the like. These components can be appropriately selected depending on the type of resin. The amount of other components contained in the binder resin may be 70 mass % or less, preferably 30 mass % or less, and more preferably 0 mass % relative to the total amount of the binder resin.

### (Liquid Medium)

The liquid medium may be an organic solvent. Examples of the organic solvent include water-soluble solvents, such as alcohols such as methanol, ethanol, isopropyl alcohol and n-propyl alcohol; ketones such as acetone and methyl ethyl ketone; glycols such as ethylene glycol and diethylene glycol; glycol ethers such as N-methylpyrrolidone (NMP), tetrahydrofuran and butyl cellosolve. In view of the fact that the organic salt and inorganic salt are deliquescent, the liquid medium may be an alcohol-based solvent, specifically, ethanol.

### (Other Components)

Examples of other components contained in the fire-extinguishing material include colorants, antioxidants, flame retardants, inorganic fillers, fluidity-imparting agents, moisture-proofing agents, dispersants, UV absorbers, flexibility-imparting agents, adhesion-imparting agents and catalysts. These components can be appropriately selected depending on the type of salt and the type of binder resin. The amount of other components contained in the fire-extinguishing material may be 40 mass % or less, preferably 10 mass % or less and more preferably 0 mass % relative to the total amount of the fire-extinguishing material.

As shown in FIGS. 2 and 3, the first and second fire-extinguishing agent layers 31 and 32 are contained in the packaging bag 38. The packaging bag may be formed by, for example, heat-sealing the four sides of two resin films. Examples of the resin constituting the resin film include polyolefin (LLDPE, PP, COP, CPP, etc.), polyester (PET, etc.), fluororesin (PTFE, ETFE, EFEP, PFA, FEP, PCTFE, etc.), PVC, PVA, acrylic resin, epoxy resin, polyamide and polyimide. These resins will melt by the heat of a flame (typically about 700° C. to 900° C.), easily exposing the fire-extinguishing sheet inside. Further, by selecting these transparent materials, it becomes easier to visually inspect the fire-extinguishing sheet and check when it should be replaced. The resin film may contain the above fire-extinguishing agent.

The water vapor transmission rate of the resin film (in accordance with JIS K 7129, under conditions of 40° C./90% RH) is not particularly limited since it can be designed according to the type of the fire-extinguishing agent, but may be 10.0 g/(m²·day) or less, and preferably 1.0 g/(m²·day) or less.

From the viewpoint of adjusting the water vapor transmission rate, the resin film may be provided with a vapor deposition layer (alumina deposition layer or silica deposition layer) having water vapor barrier properties. The vapor deposition layer may be provided on one side or both sides of the resin film. From the viewpoint of obtaining high gas barrier properties, the film constituting the packaging bag may have a layer structure containing a metal foil (e.g., aluminum foil).

### <Method of Producing Fire-Extinguishing Sheet>

First, a fire-extinguishing agent and a binder resin are mixed with a liquid medium to prepare a fire-extinguishing agent layer forming composition. The amounts of the fire-extinguishing agent and the binder resin may be adjusted so that the amounts in the fire-extinguishing agent layer become the desired amounts described above. The amount of the liquid medium may be adjusted appropriately depending on the method of use of the fire-extinguishing agent layer forming composition, but may be, for example, 40 mass % to 95 mass % relative to the total amount of the fire-extinguishing agent layer forming composition. The fire-extinguishing agent layer forming composition containing the liquid medium can be referred to as a fire-extinguishing agent layer forming coating liquid.

The fire-extinguishing agent layer forming coating liquid is applied to the resin substrate and dried to form a fire-extinguishing agent layer, thereby obtaining a laminate of the fire-extinguishing agent layer and the resin substrate. As described above, it is necessary to appropriately control the gloss on the surface of the fire-extinguishing agent layer exposed to the atmosphere, and by forming the fire-extinguishing agent layer by a coating method, an appropriate gloss can be easily achieved on both the front and rear surfaces of the fire-extinguishing agent layer. This is an advantage unique to the coating method, which does not apply strong external pressure during layer formation, and is presumably difficult to obtain with molding methods, such as press molding. The coating thickness may be appropriately adjusted to obtain a fire-extinguishing agent layer having a desired thickness, taking into consideration the pressure applied to the fire-extinguishing agent layer.

In the obtained laminate of the fire-extinguishing agent layer and the resin substrate, a fire-extinguishing agent layer forming coating liquid is further applied to the surface of the fire-extinguishing agent layer to form a fire-extinguishing agent layer in the same manner, thereby obtaining a laminate with a fire-extinguishing agent layer lamination structure. The coating can be performed by a wet coating method. Examples of the wet coating method include gravure coating, comma coating, dip coating, curtain coating, spin coating, sponge roll coating and die coating.

The method of producing a fire-extinguishing sheet may further include pressurizing the fire-extinguishing agent layer. This makes it easier to improve the gloss. From the viewpoint of easily obtaining a desired gloss, the pressure condition can be 0.2 MPa or greater, and preferably 2.0 MPa or greater. The upper limit of the pressure condition can be 2.5 MPa or less from the viewpoint of flexibility of the coating film. The laminate produced by these steps can be contained in a packaging bag to obtain a fire-extinguishing sheet 30 shown in FIGS. 2 and 3.

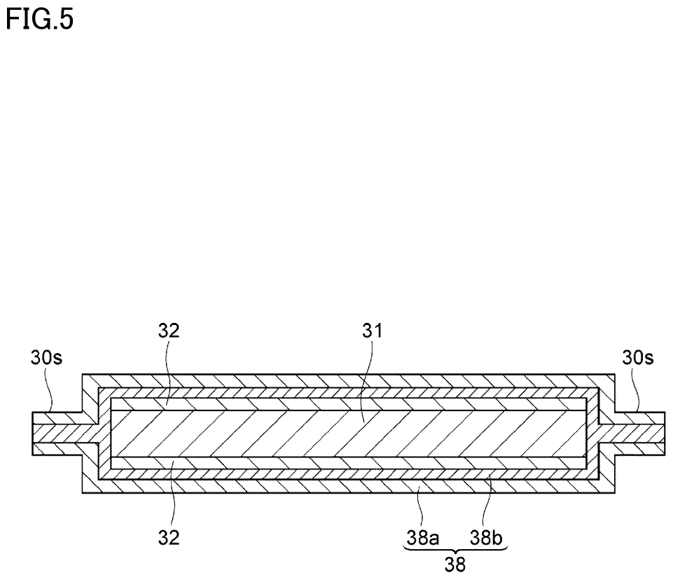

An embodiment of the present disclosure has been described, but the present disclosure should not be limited to the above embodiment. For example, in the above embodiment, a laminate having a two-layer structure composed of the first and second fire-extinguishing agent layers 31 and 32 is contained in the packaging bag, but the laminate may have a three-layer structure, as shown in FIG. 5, in which the second fire-extinguishing agent layer 32/the first fire-extinguishing agent layer 31/the second fire-extinguishing agent layer 32 are laminated in this order.

In the above embodiment, a laminate composed of a plurality of fire-extinguishing agent layers is contained in a packaging bag, but for example, a laminate including the resin substrate used when applying the fire-extinguishing agent layer may be contained in a packaging bag. Examples of the resin constituting the resin substrate include polyolefin (LLDPE, PP, COP, CPP, etc.), polyester (PET, etc.), fluororesin (PTFE, ETFE, EFEP, PFA, FEP, PCTFE, etc.), PVC, PVA, acrylic resin, epoxy resin, polyamide and polyimide. Even when the fire-extinguishing sheet is installed so that the resin substrate faces the flame, these resins will melt by the heat of a flame (typically about 700° C. to 900° C.), easily exposing the fire-extinguishing agent layer. Further, by selecting these transparent materials, it becomes easier to visually inspect the fire-extinguishing agent layer and check when the fire-extinguishing agent layer should be replaced. The resin substrate may contain the above fire-extinguishing agent.

From the viewpoint of adjusting the water vapor transmission rate, the resin substrate may be provided with a vapor deposition layer (alumina deposition layer or silica deposition layer) having water vapor barrier properties. The vapor deposition layer may be provided on one side or both sides of the resin substrate. The thickness of the resin substrate can be appropriately adjusted according to the amount of heat and impact expected in the event of a fire, allowable installation space, and the like. For example, a thick substrate can easily provide strength and rigidity as a fire-extinguishing sheet, and facilitate handling. Further, a thin substrate allows the fire-extinguishing sheet to be installed in a small space, and melts in a short time when heated by a flame, improving initial fire-extinguishing capability. The thickness of the resin substrate may be, for example, 4.5 μm to 100 μm, and preferably 12 μm to 50 μm. The resin substrate may be a laminate composed of a plurality of resin layers.

In the above embodiment, a laminate composed of a plurality of fire-extinguishing agent layers is contained in a packaging bag, but depending on the environment in which the fire-extinguishing sheet is used, the laminate may be used as is, as a fire-extinguishing sheet, without being contained in a packaging bag.

### EXAMPLES

The present invention will be described in more detail using the following examples, but the present invention is not limited to these examples.

The following materials were used in the examples and comparative examples.

### (Fire-Extinguishing Agent)

Organic potassium salt: tripotassium citrate

Oxidizing agent: potassium chlorate (KClO₃)

Tripotassium citrate is a deliquescent salt.

### (Binder Resin)

An ether-based polyurethane resin solution obtained by dissolving 100 parts by mass of an ether-based polyurethane resin in 210 parts by mass of isopropyl alcohol.

### (Liquid Medium)

Ethanol

### (Resin Substrate)

A polyethylene terephthalate (PET) substrate (manufactured by Toyobo Co., Ltd., trade name: E7002, thickness: 50 μm)

### (Anti-Deliquescence Component)

A silane coupling agent having an acid anhydride group and an alkoxysilyl group (manufactured by Shin-Etsu Chemical Co., Ltd., trade name: X-12-1287A)

### (Preparation of First Fire-Extinguishing Agent Layer Forming Composition)

A mixture of tripotassium citrate and potassium chlorate (KCIO3) was ground in an agate mortar to an average particle size D50 of 12 μm or less. 87.4 parts by mass of the ground mixture, 39.4 parts by mass of the ether-based polyurethane resin solution and 87 parts by mass of ethanol were mixed together to obtain a first fire-extinguishing agent layer forming composition.

### (Preparation of Second Fire-Extinguishing Agent Layer Forming Composition)

A mixture of tripotassium citrate and potassium chlorate (KCIO3) was ground in an agate mortar to an average particle size D50 of 12 μm or less. 87.4 parts by mass of the ground mixture, 19.7 parts by mass of the ether-based polyurethane resin solution, 6.3 parts by mass of the silane coupling agent and 87 parts by mass of ethanol were mixed together to obtain a second fire-extinguishing agent layer forming composition.

### Example 1

The first fire-extinguishing agent layer forming composition was applied to a release-treated surface of the PET substrate using an applicator, and dried at 75° C. for 7 minutes to obtain a laminate in which a first fire-extinguishing agent layer having an average thickness of 200 μm was formed on the PET substrate. The second fire-extinguishing agent layer forming composition was applied to the first fire-extinguishing agent layer of the obtained laminate using an applicator, and dried at 75° C. for 7 minutes to obtain a laminate in which a second fire-extinguishing agent layer having an average thickness of 100 μm was formed on the first fire-extinguishing agent layer. The PET substrate was removed from the laminate to thereby obtain a fire-extinguishing sheet having a two-layer configuration (first fire-extinguishing agent layer/second fire-extinguishing agent layer).

### Example 2

The second fire-extinguishing agent layer forming composition was applied to a release-treated surface of the PET substrate using an applicator, and dried at 75° C. for 7 minutes to obtain a laminate in which a second fire-extinguishing agent layer having an average thickness of 70 μm was formed on the PET substrate. The first fire-extinguishing agent layer forming composition was applied to the second fire-extinguishing agent layer of the obtained laminate using an applicator, and dried at 75° C. for 7 minutes to obtain a laminate in which a first fire-extinguishing agent layer having an average thickness of 160 μm was formed on the second fire-extinguishing agent layer. The second fire-extinguishing agent layer forming composition was applied to the first fire-extinguishing agent layer of the obtained laminate using an applicator, and dried at 75° C. for 7 minutes to obtain a laminate in which a second fire-extinguishing agent layer having an average thickness of 70 μm was further formed on the first fire-extinguishing agent layer. The PET substrate was removed from the laminate to thereby obtain a fire-extinguishing sheet having a three-layer configuration (second fire-extinguishing agent layer/first fire-extinguishing agent layer/second fire-extinguishing agent layer).

### Example 3

A fire-extinguishing sheet was obtained in the same manner as in Example 1, except that the first fire-extinguishing agent layer forming composition was applied to a non-release-treated surface of the PET substrate and the PET substrate was not removed.

### Comparative Example 1

The first fire-extinguishing agent layer forming composition was applied to a release-treated surface of the PET substrate using an applicator, and dried at 75° C. for 7 minutes to obtain a laminate in which a first fire-extinguishing agent layer having an average thickness of 300 μm was formed on the PET substrate. The PET substrate was removed from the laminate to thereby obtain a fire-extinguishing sheet having a single-layer configuration composed of only the first fire-extinguishing agent layer.

### Comparative Example 2

The second fire-extinguishing agent layer forming composition was applied to a release-treated surface of the PET substrate using an applicator, and dried at 75° C. for 7 minutes to obtain a laminate in which a second fire-extinguishing agent layer having an average thickness of 300 μm was formed on the PET substrate. The PET substrate was removed from the laminate to thereby obtain a fire-extinguishing sheet having a single-layer configuration composed of only the second fire-extinguishing agent layer.

### Examples 4 to 10

A fire-extinguishing sheet was obtained in the same manner as in Example 3, except that the thicknesses of the first fire-extinguishing agent layer and the second fire-extinguishing agent layer were changed to those shown in Tables 2 and 3.

### Example 11

A fire-extinguishing sheet was obtained in the same manner as in Example 2, except that the second fire-extinguishing agent layer forming composition was applied to a non-release-treated surface of the PET substrate, the PET substrate was not removed, and the thicknesses of the first fire-extinguishing agent layer and the second fire-extinguishing agent layer were changed to those shown in Table 3.

### <Various Evaluations>

A barrier film (water vapor transmission ratio 0.2 to 0.6 g/(m²·day), in accordance with JIS K 7129, under conditions of 40° C./90% RH) was prepared, which includes a sealant layer (L-LDPE (linear low-density polyethylene) resin, thickness: 30 μm) and a substrate layer (PET (polyethylene terephthalate) resin with a silica deposition layer, thickness: 12 μm). Two sheets of this barrier film were used to cover the fire-extinguishing sheet (50 mm×50 mm) obtained in each example, and four sides of the barrier film were heat-sealed to enclose the fire-extinguishing sheet. The heat-sealing conditions were 140° C. and 2 seconds. The heat-seal width on each side was 10 mm. As a result, a fire-extinguishing material package (a fire-extinguishing sheet contained in a packaging bag) with outer dimensions of 70 mm×70 mm was obtained. This was used as an evaluation sample. The evaluation samples obtained from the respective examples were subjected to the following evaluation tests. Tables 1 to 3 show the results.

### (Fire-Extinguishing Performance Evaluation Test)

In this test, a fire-extinguishing material package was placed above the flame to examine the performance of the fire-extinguishing material package. That is, an iron container measuring 20 cm in length, 30 cm in width and 40 cm in height was prepared. In order to prevent the ignited solid fuel from being extinguished by smothering, five circular vent holes with a diameter of 8.5 mm were formed on each side surface of the container at heights of 5.0 cm, 12.5 cm, 20.0 cm, 27.5 cm and 35.0 cm from the top. The fire-extinguishing material package (evaluation sample) was attached to the center of the top of the container with double-sided tape. 1.5 g of a solid fuel (solid fuel fire block ignition agent manufactured by Captain Stag Co., Ltd.) measuring 15 mm in length, 15 mm in width and 10 mm in height was placed at the center of the bottom of the container. The evaluation sample was examined whether it could extinguish the solid fuel within 180 seconds after ignition at each distance while adjusting the distance between the solid fuel and the evaluation sample to 10 cm, 15 cm and 20 cm. Of the first and second fire-extinguishing agent layers, the layer facing the flame was as shown in Table 1.

### (Property Stability Evaluation Test)

The total light transmittance of the evaluation sample was measured in accordance with JIS K 7361-1, using a haze meter (BYK-Gardner Haze-Guard Plus manufactured by BYK). The fire-extinguishing sheet obtained in each sample was left to stand under the conditions of 25° C./30% RH for 24 hours, and then enclosed in a barrier film to prepare a fire-extinguishing material package, which was used as an evaluation sample. The measurement was performed before the sample was stored in a constant temperature and humidity chamber (under conditions of 85° C./85% RH) (initial total light transmittance) and 168 hours after it was stored (total light transmittance after storage), and change in total light transmittance A between before and after storage was calculated. When deliquescence of the salt occurs, the transparency of the fire-extinguishing sheet increases, and therefore the change A was used to evaluate the degree of deliquescence. The less likely the deliquescence of the salt is to occur, the more stable the properties of the fire-extinguishing sheet.

Change in total light transmittance Δ=total light transmittance value after storage−initial total light transmittance value

The evaluations were made based on the following criteria.
A: The change in total light transmittance Δ was 30 or less.
B: The change in total light transmittance Δ was greater than 30 and 50 or less.
C: The change in total light transmittance Δ was greater than 50.

TABLE 1

| | | | | | | Comp. | Comp. |
|---|---|---|---|---|---|---|---|
| | | | Example 1 | Example 2 | Example 3 | example 1 | example 2 |
| Configuration | Second fire- | Yes/No | Yes | Yes | Yes | No | Yes |
| of fire- | extinguishing | Average | 100 | 70 | 100 | — | 300 |
| extinguishing | agent layer | thickness (μm) | | | | | |
| sheet | First fire- | Yes/No | Yes | Yes | Yes | Yes | No |
| | extinguishing | Average | 200 | 160 | 200 | 300 | — |
| | agent layer | thickness (μm) | | | | | |
| | Second fire- | Yes/No | No | Yes | No | No | No |
| | extinguishing | Average | — | 70 | — | — | — |
| | agent layer | thickness (μm) | | | | | |
| | Resin | Yes/No | No | No | Yes | No | No |
| | substrate | Average | — | — | 50 | — | — |
| | | thickness (μm) | | | | | |
| Layer facing flame | | | Second | Second | Second | First fire- | Second |
| | | | fire- | fire- | fire- | extinguishing | fire- |
| | | | extinguishing | extinguishing | extinguishing | agent | extinguishing |
| | | | agent | agent | agent | layer | agent |
| | | | layer | layer | layer | | layer |
| Results | Fire- | Distance 10 cm | 100% | 100% | 100% | 100% | 0% |
| | extinguishing | | (3/3) | (1/1) | (3/3) | (3/3) | (0/3) |
| | rate | Distance 15 cm | 100% | No Data | 100% | 100% | 0% |
| | | | (3/3) | | (3/3) | (3/3) | (0/3) |
| | | Distance 20 cm | 100% | No Data | 100% | 50% | 0% |
| | | | (3/3) | | (3/3) | (2/4) | (0/3) |

| | | | | | |
|---|---|---|---|---|---|
| Property stability evaluation | A | A | A | C | A |
| Change in total light | 22.5 | 14.2 | 20.4 | 60 | 4.2 |
| transmittance Δ | | | | | |

TABLE 2

| | | | Example 4 | Example 5 | Example 6 | Example 7 | Example 8 |
|---|---|---|---|---|---|---|---|
| Configuration | Second fire- | Yes/No | Yes | Yes | Yes | Yes | Yes |
| of fire- | extinguishing | Average | 120 | 40 | 130 | 120 | 40 |
| extinguishing | agent layer | thickness (μm) | | | | | |
| sheet | First fire- | Yes/No | Yes | Yes | Yes | Yes | Y |
| | extinguishing | Average | 200 | 200 | 180 | 150 | 150 |
| | agent layer | thickness (μm) | | | | | |
| | Second fire- | Yes/No | No | No | No | No | No |
| | extinguishing | Average | — | — | — | — | — |
| | agent layer | thickness (μm) | | | | | |
| | Resin | Yes/No | Yes | Yes | Yes | Yes | Yes |
| | substrate | Average | 50 | 50 | 50 | 50 | 50 |
| | | thickness (μm) | | | | | |
| Layer facing flame | | | Second | Second | Second | First fire- | Second |
| | | | fire- | fire- | fire- | extinguishing | fire- |
| | | | extinguishing | extinguishing | extinguishing | agent | extinguishing |
| | | | agent | agent | agent | layer | agent |
| | | | layer | layer | layer | | layer |
| Results | Fire- | Distance 10 cm | No Data | No Data | No Data | No Data | No Data |
| | extinguishing | Distance 15 cm | No Data | No Data | No Data | No Data | No Data |
| | rate | Distance 20 cm | 71% | 71% | 66% | 86% | 86% |
| | | | (5/7) | (5/7) | (2/3) | (6/7) | (6/7) |

| | | | | | |
|---|---|---|---|---|---|
| Property stability evaluation | A | B | A | A | B |
| Change in total light | 19.4 | 48.6 | 12.2 | 20.1 | 47.8 |
| transmittance Δ | | | | | |

TABLE 3

| | | | Example 9 | Example 10 | Example 11 |
|---|---|---|---|---|---|
| Configuration | Second fire- | Yes/No | Yes | Yes | Yes |
| of fire- | extinguishing | Average | 120 | 40 | 40 |
| extinguishing | agent layer | thickness (μm) | | | |
| sheet | First fire- | Yes/No | Yes | Yes | Yes |
| | extinguishing | Average | 100 | 100 | 150 |
| | agent layer | thickness (μm) | | | |
| | Second fire- | Yes/No | No | No | Yes |
| | extinguishing | Average | — | — | 40 |
| | agent layer | thickness (μm) | | | |
| | Resin | Yes/No | Yes | Yes | Yes |
| | substrate | Average | 50 | 50 | 50 |
| | | thickness (μm) | | | |
| Layer facing flame | | | Second fire- | Second fire- | Second fire- |
| | | | extinguishing | extinguishing | extinguishing |
| | | | agent layer | agent layer | agent layer |
| Results | Fire- | Distance | No Data | No Data | No Data |
| | extinguishing | 10 cm | | | |
| | rate | Distance | No Data | No Data | No Data |
| | | 15 cm | | | |
| | | Distance | 71% (5/7) | 71% (5/7) | 71% (5/7) |
| | | 20 cm | | | |

| | | | |
|---|---|---|---|
| Property stability evaluation | A | B | B |
| Change in total light | 23.6 | 46.9 | 30.8 |
| transmittance Δ | | | |

In Tables 1 to 3, the notation in parentheses for the fire-extinguishing rate means the “number of successful extinguishments/number of tests”. The “distance” for the fire-extinguishing rate means the distance from the solid fuel to the evaluation sample.

The evaluation samples of the Example 1 and Comparative Examples 1 and 2 were further examined for the following evaluation.

### (Fire-Extinguishing Performance Evaluation Test 1)

In this test, a fire-extinguishing material package was placed above the flame to examine the performance of the fire-extinguishing material package. That is, an iron container having the same configuration as above was prepared. The fire-extinguishing material package (evaluation sample) was attached to the center of the top of the container with double-sided tape. 1.5 g of a solid fuel (solid fuel fire block ignition agent manufactured by Captain Stag Co., Ltd.) measuring 15 mm in length, 15 mm in width and 10 mm in height was placed at the center of the bottom of the container. The evaluation sample was examined whether it could extinguish the solid fuel within 180 seconds after ignition at each distance while adjusting the distance between the solid fuel and the evaluation sample to 10 cm, 15 cm and 20 cm. Of the first and second fire-extinguishing agent layers, the layer facing the flame was as shown in Table 4. The evaluations were made based on the following criteria.
A: The fire was extinguished at a distance of 20 cm from the solid fuel to the evaluation sample.
B: The fire was extinguished at a distance of 10 cm from the solid fuel to the evaluation sample.
C: The fire was not extinguished at a distance of 10 cm from the solid fuel to the evaluation sample.

### (Fire-Extinguishing Performance Evaluation Test 2)

In this test, a fire-extinguishing material package was placed vertically at a position horizontally separated from the flame to examine the performance of the fire-extinguishing material package. That is, an iron container having the same configuration as above was prepared. The fire-extinguishing material package (evaluation sample) was attached to the center of the rear inner surface of the container with double-sided tape. 1.5 g of a solid fuel (solid fuel fire block ignition agent manufactured by Captain Stag Co., Ltd.) measuring 15 mm in length, 15 mm in width and 10 mm in height was placed in front of the evaluation sample at the same height as the bottom of the evaluation sample. The evaluation sample was examined whether it could extinguish the solid fuel within 180 seconds after ignition at each distance while adjusting the horizontal distance between the solid fuel and the evaluation sample to 5 mm and 10 mm. Of the first and second fire-extinguishing agent layers, the layer facing the flame was as shown in Table 4. The evaluations were made based on the following criteria.
A: The fire was extinguished at a distance of 10 mm from the solid fuel to the evaluation sample.
B: The fire was extinguished at a distance of 5 mm from the solid fuel to the evaluation sample.
C: The fire was not extinguished at a distance of 5 mm from the solid fuel to the evaluation sample.

TABLE 4

| | | | | Comp. | Comp. |
|---|---|---|---|---|---|
| | | | Example | example | example |
| | | | 1 | 1 | 2 |
| Configuration | First fire- | Yes/No | Yes | Yes | No |
| of fire- | extinguishing | Average | 200 | 300 | — |
| extinguishing | agent layer | thickness (μm) | | | |
| sheet | Second fire- | Yes/No | Yes | No | Yes |
| | extinguishing | Average | 100 | — | 300 |
| | agent layer | thickness (μm) | | | |

| Layer facing flame | | First fire- | First fire- | Second fire- |
|---|---|---|---|---|
| | | extinguishing | extinguishing | extinguishing |
| | | agent layer | agent layer | agent layer |
| Results | Fire-extinguishing | B | A | C |
| | performance | | | |
| | evaluation test 1 | | | |
| | Fire-extinguishing | B | A | C |
| | performance | | | |
| | evaluation test 2 | | | |
| | Property stability | A | C | A |
| | evaluation | | | |

As shown in Table 4, the result of the fire-extinguishing performance evaluation test 2 of Example 1 was B. The reason for this seems to be that the flame was small and the fire-extinguishing sheet placed next to the flame was not easily heated. For example, in the case of an intense flame, such as when a switchboard ignites, the fire-extinguishing function can be expected even if the fire-extinguishing sheet is installed at a certain distance from the flame.
[Reference Signs List] 30, 30a, 30b, 30c, 30d . . . Fire-extinguishing sheet 30s . . . Seal portion
31 . . . First fire-extinguishing agent layer 32 . . . Second fire-extinguishing agent layer 38 . . . Packaging bag 1F . . . Surface of the fire-extinguishing sheet on the first fire-extinguishing agent layer side
2F . . . Surface of the fire-extinguishing sheet on the second fire-extinguishing agent layer side
100 . . . Electrical installation (device having automatic fire-extinguishing function) 101 . . . Housing 101a . . . Housing section 101b . . . Openable door 102 . . . Wiring cover 103 . . . Breaker 104 . . . Wiring

What is claimed is:

1. A fire-extinguishing sheet having a laminate structure comprising a first fire-extinguishing agent layer and a second fire-extinguishing agent layer, wherein
each of the first and second fire-extinguishing agent layers contains a fire-extinguishing agent,
the fire-extinguishing agent contains at least one of a salt which is a deliquescent organic salt and a salt which is a deliquescent inorganic salt, and
the second fire-extinguishing agent layer further contains an anti-deliquescence component.

2. The fire-extinguishing sheet according to claim 1, wherein
the fire-extinguishing agent is configured to be ejected in response to flames.

3. The fire-extinguishing sheet according to claim 2, wherein
the second fire-extinguishing agent layer has a lower responsiveness to flames than the first fire-extinguishing agent layer does.

4. The fire-extinguishing sheet according to claim 1, wherein
the anti-deliquescence component contains a compound having an acid anhydride group.

5. The fire-extinguishing sheet according to claim 4, wherein
the compound having an acid anhydride group is a silane coupling agent having a carboxylic acid anhydride group and an alkoxysilyl group.

6. The fire-extinguishing sheet according to claim 1, wherein
the first fire-extinguishing agent layer contains a first fire-extinguishing agent,
the second fire-extinguishing agent layer contains a second fire-extinguishing agent, and
the salt contained in the first fire-extinguishing agent is the same compound as the salt contained in the second fire-extinguishing agent.

7. The fire-extinguishing sheet according to claim 1, wherein
the first fire-extinguishing agent layer contains a first fire-extinguishing agent,
the second fire-extinguishing agent layer contains a second fire-extinguishing agent, and
at least one of the first and second fire-extinguishing agents further contains an oxidizing agent.

8. The fire-extinguishing sheet according to claim 1, wherein
when a 2.0 μL water droplet is dropped onto the second fire-extinguishing agent layer, a contact angle 0.2 seconds after dropping is 75° or greater.

9. The fire-extinguishing sheet according to claim 1, wherein
change in total light transmittance A calculated by the following formula (1) based on the result of a property stability evaluation test is 50 or less:
$$change in total light transmittance Δ = total light transmittance value after storage - initial total light transmittance value \qquad ( 1 )$$

10. The fire-extinguishing sheet according to claim 1, wherein
when the fire-extinguishing sheet is disposed with the first fire-extinguishing agent layer located above and the second fire-extinguishing agent layer located below, and a bottom of the fire-extinguishing sheet is heated with a flame from below the fire-extinguishing sheet to cause the fire-extinguishing agent to react with the flame, a reaction region in the second fire-extinguishing agent layer has a smaller area than that in the first fire-extinguishing agent layer.

11. The fire-extinguishing sheet according to claim 1, wherein
the fire-extinguishing sheet is contained in a packaging bag having gas barrier properties.

12. A device having an automatic fire-extinguishing function, the device comprising:
a fire-extinguishing object having a possibility of ignition; and
a fire-extinguishing sheet disposed facing the fire-extinguishing object, wherein
the fire-extinguishing sheet has a laminate structure including a first fire-extinguishing agent layer and a second fire-extinguishing agent layer,
each of the first and second fire-extinguishing agent layers contains a fire-extinguishing agent configured to be ejected in response to flames,
the fire-extinguishing agent contains at least one of a salt which is a deliquescent organic salt and a salt which is a deliquescent inorganic salt, and
the second fire-extinguishing agent layer further contains an anti-deliquescence component.

13. The device having an automatic fire-extinguishing function according to claim 12, wherein
the fire-extinguishing object is one selected from the group consisting of a switchboard, a distribution board, a control panel, a storage battery and an electrical outlet, and
the fire-extinguishing sheet is installed on an inner surface of a housing that accommodates the fire-extinguishing object.

14. The device having an automatic fire-extinguishing function according to claim 12, wherein
the second fire-extinguishing agent layer has a lower responsiveness to flames than the first fire-extinguishing agent layer does and is disposed closer to the fire-extinguishing object than the first fire-extinguishing agent layer is.

15. The device having an automatic fire-extinguishing function according to claim 14, wherein
the fire-extinguishing sheet is disposed above the fire-extinguishing object.

16. The device having an automatic fire-extinguishing function according to claim 12, wherein
the first fire-extinguishing agent layer has a higher responsiveness to flames than the second fire-extinguishing agent layer does and is disposed closer to the fire-extinguishing object than the second fire-extinguishing agent layer is.

17. The device having an automatic fire-extinguishing function according to claim 16, wherein
the fire-extinguishing sheet is disposed at a position horizontally separated from the fire-extinguishing object.
